(19) United States
(12) Patent Application Publication
(10) Pub. No.: US 2016/0381755 A1
(43) Pub. Date: Dec. 29, 2016

(54) GRAVITY SENSING FLASHLIGHT AND ITS ELECTRIC CONTROL CIRCUIT

(71) Applicant: NINGBO FUTAI ELECTRIC LIMITED, Ningbo City, Zhejiang (CN)

(72) Inventor: FUJUN QIU, NINGBO, ZHEJIANG PROVINCE (CN)

(21) Appl. No.: 14/896,968

(22) PCT Filed: Mar. 27, 2015
(86) PCT No.: PCT/CN2015/075182

§ 371 Date: Dec. 9, 2015

(30) Foreign Application Priority Data
Mar. 5, 2015 (CN) 201510097166.4

(51) Int. Cl. H05B 33/08; F21V 23/04; F21L 4/00

(52) U.S. Cl. CPC H05B 33/0848; F21L 4/00; F21V 23/0414; F21Y 2115/10

(57) ABSTRACT

The present invention discloses a gravity sensing flashlight, including a lamp holder, a cylindrical body and a tail cover, the lamp holder being connected to a head end of the cylindrical body, the tail cover being connected to a tail end of the cylindrical body, a storage battery as a power supply being internally provided in the cylindrical body, a switch being additionally mounted on a side wall of the cylindrical body, a circuit board being mounted in the switch, a gravity sensor and an indicator light being provided on the circuit board; the lamp holder consists of a shell cap, a shell body and a shell base which are in threaded connection to each other, a lens, a lens holder, an LED lamp bead and a lamp bead fixing frame being mounted in the shell body, a current chip controller being mounted on the lamp bead fixing frame, one end of the current chip controller being connected to the LED lamp bead while the other end thereof being connected to the gravity sensor. The gravity sensing flashlight provided by the present invention can automatically judge and adjust brightness according to the change in action of a user in using the flashlight at a far/near distance, thereby realizing the effects of saving energy and prolonging the service life of a battery.

### TECHNICAL FIELD

The present invention relates to the lighting field, in particular to a gravity sensing flashlight and its electric control circuit.

### BACKGROUND OF THE PRESENT INVENTION

Through researches on people's daily action habits of using a flashlight, it has been found that people's hands holding the flashlight will generate a downward action when the flashlight is used to illuminate a near distance, because quite bright light is not required at this time; however, people's hands holding the flashlight will generate an upward action when the flashlight is used to illuminate a far distance, so that it is indicated that highest brightness is required at this time. As the brightness of an prior art flashlight is fixed or its brightness adjustment will not be automatically changed according to environmental needs, the relay ability of the flashlight is low and the service life is even reduced due to the use in high brightness.

### SUMMARY OF THE PRESENT INVENTION

The object of the present invention is to solve the deficiencies of the prior art and provide a gravity sensing flashlight and an electric control circuit, with brightness adjustment being automatically changed according to environmental needs.

To achieve the above object, the present invention designs a gravity sensing flashlight, including a lamp holder, a cylindrical body and a tail cover, the lamp holder being connected to a head end of the cylindrical body, the tail cover being connected to a tail end of the cylindrical body, a storage battery as a power supply being internally provided in the cylindrical body, a switch being additionally mounted on a side wall of the cylindrical body, wherein the switch consists of a switch leather sheath, a knockout rod, a knockout rod fixing frame and a circuit board fixing frame in turn from inside to outside, a circuit board being mounted on the circuit board fixing frame, a gravity sensor, a switch button and an indicator light being provided on the circuit board; and, the lamp holder consists of a shell cap, a shell body and a shell base which are in threaded connection to each other, a lens, a lens holder, an LED lamp bead and a lamp bead fixing frame being mounted in the shell body, a current chip controller being mounted on the lamp bead fixing frame, one end of the current chip controller being connected to the LED lamp bead while the other end thereof being connected to the gravity sensor.

The switch not only may turn on or off the power supply, but also may switch the operating mode of the flashlight. When the flashlight is at a normal mode, three different modes, i.e., a high mode, a low mode and a flashing mode, may be controlled by the switch. Here, the three modes are switched by the knockout rod in the switch. When the flashlight is switched to an automatic mode, the flashlight may automatically judge and adjust brightness according to the change in action of a user in using the flashlight at a far/near distance, thereby realizing the effects of saving energy and prolonging the service life of a battery. In the actual use of the product, during a switchover between far distance illumination and near distance illumination, by virtue of the change of this action, a gravity sensor sends a signal to the current chip controller to adjust the current, thereby achieving the purpose of automatically adjusting brightness, greatly saving the electric quantity of the battery and prolonging the service life of the battery.

To fix an LED lamp bead in the cylindrical body of the flashlight more steadily, a mounting bracket consisting of more than three arc surfaces is provided on the shell base of the lamp holder, with an adjusting base being sheathed outside the mounting bracket, a rotating base being inserted inside the mounting bracket, a lug being provided on the rotating base, the width of the lug being the same as the width of a gap between the arc surfaces. The specific installation is as follows: the lug on the rotating base is firstly clamped on the mounting bracket of the shell base through the gap between the arc surfaces, then the LED lamp bead and the lamp bead fixing frame are together fixed on the rotating base, and the adjusting base is sheathed outside the mounting bracket, so that the whole internal structure becomes steady. Meanwhile, a conical surface fitted with the lamp bead fixing frame in the shell body is provided at an upper end of the rotating base. To be convenient to mount the adjusting base on the mounting bracket, the outer side of the adjusting base is in a hexagon or an octagon shape.

For mounting convenience, the tail cover is in detachable connection to the cylindrical body; meanwhile, to improve the air-tightness between the tail cover and the cylindrical body, a sealing ring is provided between the tail cover and the cylindrical body. An electric control circuit for the gravity sensing flashlight is provided, comprising a power supply circuit, a current chip circuit, a gravity sensing circuit and an LED lamp bead circuit, wherein the current chip circuit is in signal connected to the gravity sensing circuit through a switch; the power supply circuit comprises a power supply chip; the current chip circuit comprises a current chip; the gravity sensing circuit comprises a gravity sensing chip; and, the LED lamp bead circuit comprises an LED lamp, a field effect transistor and a first resistor.

In the gravity sensing flashlight provided by the present invention, the switch not only may turn on or off the power supply, but also may switch the operating mode of the flashlight. When the flashlight is at a normal mode, three different modes, i.e., a high mode, a low mode and a flashing mode, may be controlled by the switch. Here, the three modes are switched by the knockout rod in the switch. When the flashlight is switched to an automatic mode, the flashlight may automatically judge and adjust brightness according to the change in action of a user in using the flashlight at a far/near distance, thereby realizing the effects of saving energy and prolonging the service life of a battery. In the actual use of the product, during a switchover between far distance illumination and near distance illumination, by virtue of the change of this action, a gravity sensor sends a signal to the current chip controller to adjust the current, thereby achieving the purpose of automatically adjusting brightness, greatly saving the electric quantity of the battery and prolonging the service life of the battery. Meanwhile, the internal structures of the gravity sensing flashlight are fixed layer by layer, so the LED lamp bead may be stably disposed in the flashlight.

### BRIEF DESCRIPTION OF THE DRAWINGS

FIG. 1 is a structure diagram of a gravity sensing flashlight according to Embodiment 1;

FIG. 2 is an exploded view of a switch in the gravity sensing flashlight according to Embodiment 1;

FIG. 3 is an internal exploded view of a lamp holder in the gravity sensing flashlight according to Embodiment 1;

FIG. 4 is a flow chart of a control circuit of the gravity sensing flashlight according to Embodiment 1;

FIG. 5 is a schematic diagram of the control circuit of the gravity sensing flashlight according to Embodiment 1;

FIG. 6 is an exploded view of a lamp holder in a gravity sensing flashlight according to Embodiment 2; and

FIG. 7 is an overall exploded view of the gravity sensing flashlight according to Embodiment 2;

in which:

1: Lamp holder;

2: Cylindrical body;

3: Tail cover;

4: Switch;

5: Arc surfaces;

6: Mounting bracket;

7: Adjusting base;

8: Rotating base;

9: Lug;

10: Sealing ring;

11: Shell cap;

12: Shell body;

13: Shell base;

14: Lens;

15: Lens holder;

16: LED lamp bead;

17: Lamp bead fixing frame;

18: Current chip controller;

41: Switch leather sheath;

42: Knockout rod;

43: Knockout rod fixing frame;

44: Circuit board fixing frame;

45: Circuit board;

46: Gravity sensor;

47: Switch button;

48: Indicator light;

51: Power supply circuit;

52: Current chip circuit;

53: Gravity sensing circuit;

54: LED lamp bead circuit;

U1: Current chip;

U2: Gravity sensing chip;

U3: Power supply chip;

L1: LED lamp;

Q1: Field effect transistor; and

R1: First resistor.

### DETAILED DESCRIPTION OF THE PRESENT INVENTION

The present invention will be further described as below with reference to the drawings by embodiments.

Embodiment 1:

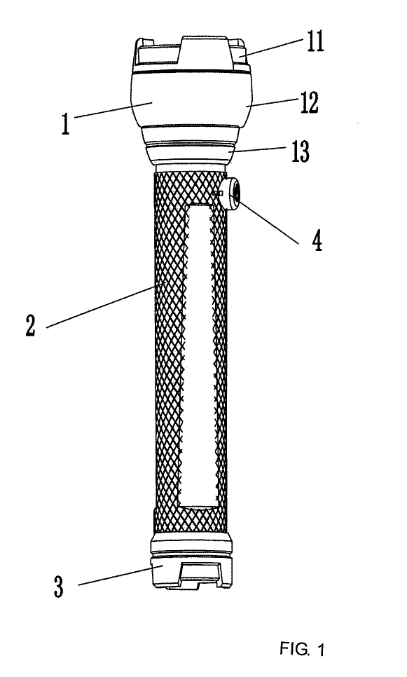

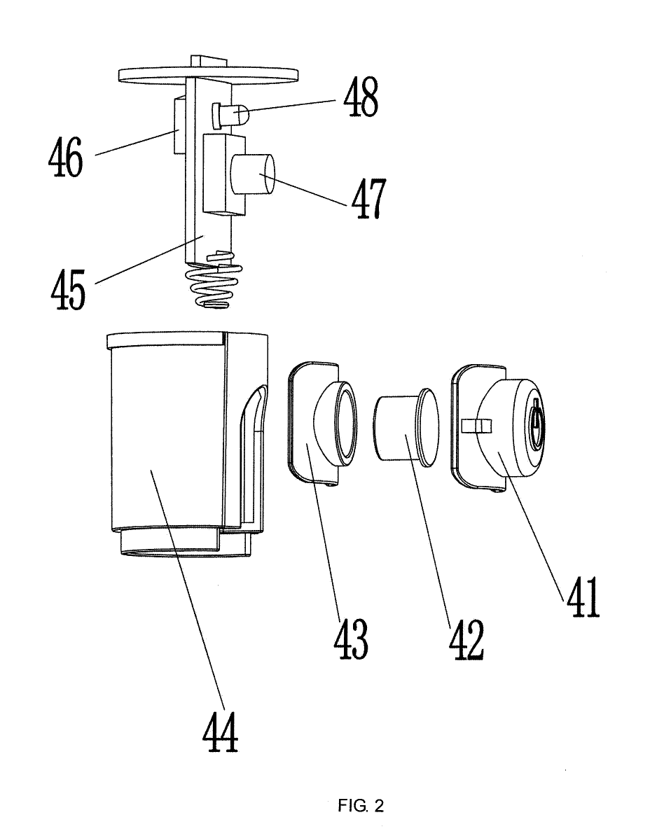

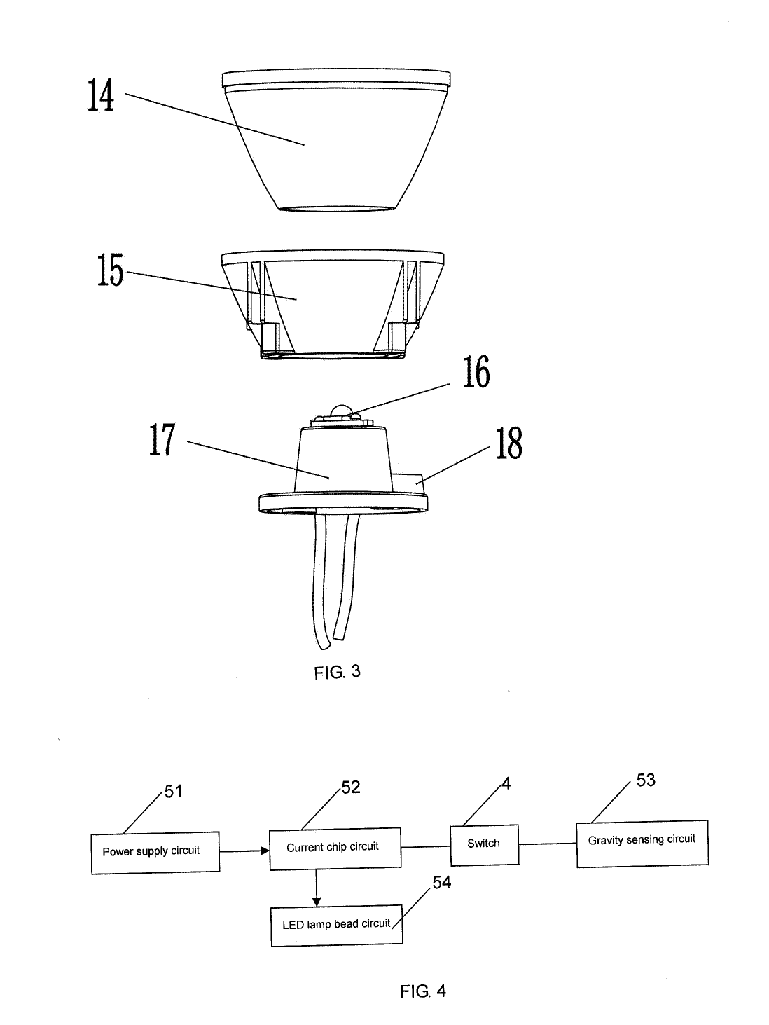

As shown in FIG. 1, FIG. 2 and FIG. 3, this embodiment provides a gravity sensing flashlight, comprising a lamp holder 1, a cylindrical body 2 and a tail cover 3, the lamp holder 1 being connected to a head end of the cylindrical body 2, the tail cover 3 being connected to a tail end of the cylindrical body 2, a storage battery as a power supply being internally provided in the cylindrical body 2, a switch 4 being additionally mounted on a side wall of the cylindrical body 2, wherein the switch 4 consists of a switch leather sheath 41, a knockout rod 42, a knockout rod fixing frame 43 and a circuit board fixing frame 44 in turn from inside to outside, with a circuit board 45 being mounted on the circuit board fixing frame 44, and a gravity sensor 46, a switch button 47 and an indicator light 48 being provided on the circuit board 45; and, the lamp holder 1 consists of a shell cap 11, a shell body 12 and a shell base 13 which are in threaded connection to each other, with a lens 14, a lens holder 15, an LED lamp bead 16 and a lamp bead fixing frame 17 being mounted in the shell body 12, a current chip controller being mounted on the lamp bead fixing frame 17, one end of the current chip controller 18 being connected to the LED lamp bead 16 while the other end thereof being connected to the gravity sensor 46.

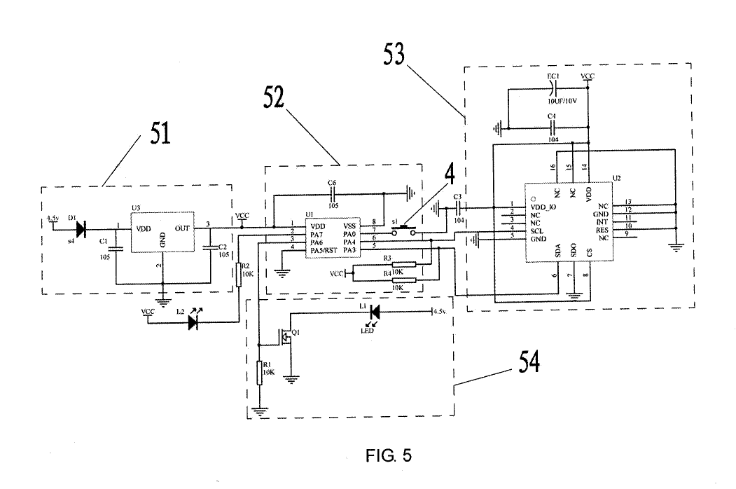

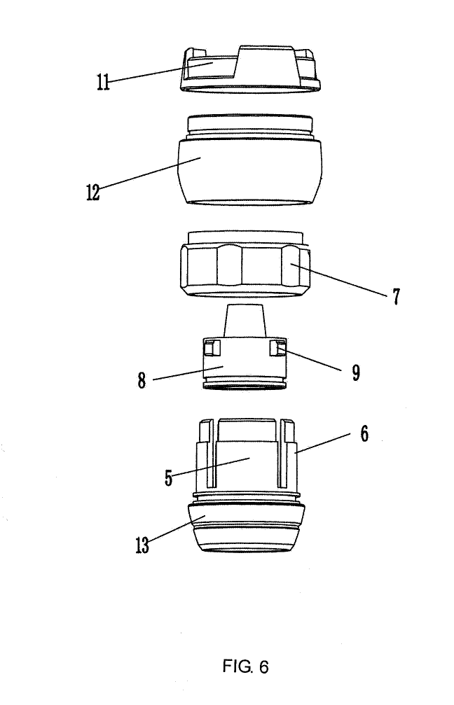

As shown in FIG. 4 and FIG. 5, a control circuit for the gravity sensing flashlight is provided, comprising a power supply circuit 51, a current chip circuit 52, a gravity sensing circuit 53 and an LED lamp bead circuit 54 which are connected in turn, wherein the current chip circuit 52 is in signal connected to the gravity sensing circuit 53 through a switch 4; the power supply circuit 51 comprises a power supply chip U3; the current chip circuit 52 comprises a current chip U1; the gravity sensing circuit 53 comprises a gravity sensing chip U2; and, the LED lamp bead circuit 54 comprises an LED lamp L1, a field effect transistor Q1 and a first resistor R1.

In the gravity sensing flashlight provided by the present invention, the switch not only may turn on or off the power supply, but also may switch the operating mode of the flashlight. When the flashlight is at a normal mode, three different modes, i.e., a high mode, a low mode and a flashing mode, may be controlled by the switch 4. Here, the three modes are switched by the knockout rod 42 in the switch 4. When the flashlight is switched to an automatic mode, the flashlight may automatically judge and adjust brightness according to the change in action of a user in using the flashlight at a far/near distance, thereby achieving the effects of saving energy and prolonging the service life of a battery. In the actual use of the product, during a switchover between far distance illumination and near distance illumination, by virtue of the change of this action, the gravity sensor 46 sends a signal to the current chip controller 18 to adjust the current, thereby achieving the purpose of automatically adjusting brightness, greatly saving the electric quantity of the battery and prolonging the service life of the battery.

Embodiment 2:

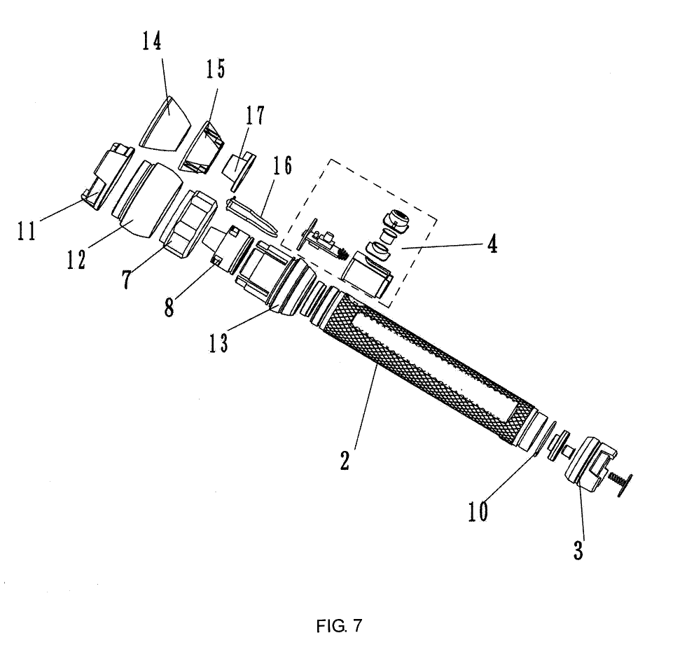

As shown in FIG. 6, this embodiment provides a gravity sensing flashlight and a control circuit. The general structure is the same as Embodiment 1, but when in specific use, to fix an LED lamp bead in the cylindrical body of the flashlight more steadily, a mounting bracket 6 consisting of more than three arc surfaces 5 is provided on the shell base 13 of the lamp holder 1. An adjusting base 7 is sheathed outside the mounting bracket 6, and a rotating base 8 inserted inside the mounting bracket 6. A lug 9 is provided on the rotating base 8, with the width of the lug 9 being the same as the width of a gap between the arc surfaces 5. A conical surface which may be fitted with the lamp bead fixing frame 17 in the shell body 12 is provided at an upper end of the rotating base 8. The outer side of the adjusting base 7 is a hexagon or an octagon. The specific installation is as follows: the lug 9 on the rotating base 8 is first clamped on the mounting bracket 6 of the shell base through the gap between the arc surfaces 5, then the LED lamp bead 16 and the lamp bead fixing frame 17 are together fixed on the rotating base 8, and the adjusting base 7 is sheathed outside the mounting bracket 6, so that the whole internal structure becomes steady. The internal structures of the gravity sensing flashlight are fixed layer by layer, so the LED lamp bead 16 may be stably disposed in the flashlight.

Embodiment 3

As shown in FIG. 7, this embodiment provides a gravity sensing flashlight and a control circuit. The general structure is the same as Embodiment 2, but when in specific use, for mounting convenience, the tail cover 3 is in detachable connection to the cylindrical body 2; meanwhile, to improve the air-tightness between the tail cover 3 and the cylindrical body 2, a sealing ring 10 is provided between the tail cover 3 and the cylindrical body 2.

1. A gravity sensing flashlight, comprising a lamp holder, a cylindrical body and a tail cover, the lamp holder being connected to a head end of the cylindrical body, the tail cover being connected to a tail end of the cylindrical body, a storage battery as a power supply being internally provided in the cylindrical body, a switch being additionally mounted on a side wall of the cylindrical body, characterized in that the switch consists of a switch leather sheath, a knockout rod, a knockout rod fixing frame and a circuit board fixing frame in turn from inside to outside, a circuit board being mounted on the circuit board fixing frame, a gravity sensor, a switch button and an indicator light being provided on the circuit board; and, the lamp holder consists of a shell cap, a shell body and a shell base which are in threaded connection to each other, a lens, a lens holder, an LED lamp bead and a lamp bead fixing frame being mounted in the shell body, a current chip controller being mounted on the lamp bead fixing frame, one end of the current chip controller being connected to the LED lamp bead while the other end thereof being connected to the gravity sensor.

2. The gravity sensing flashlight according to claim 1, characterized in that the shell base of the lamp holder is provided thereon with a mounting bracket consisting of more than three arc surfaces, an adjusting base being sheathed outside the mounting bracket, a rotating base being inserted inside the mounting bracket, a lug being provided on the rotating base, the width of the lug being the same as the width of a gap between the arc surfaces.

3. The gravity sensing flashlight according to claim 2, characterized in that a conical surface fitted with the lamp bead fixing frame in the shell body is provided at an upper end of the rotating base.

4. The gravity sensing flashlight according to claim 2, characterized in that an outer side of the adjusting base is in a hexagon or an octagon shape.

5. The gravity sensing flashlight according to claim 1, characterized in that the tail cover is in detachable connection to the cylindrical body, and a sealing ring is provided between the tail cover and the cylindrical body.

6. A control circuit for the gravity sensing flashlight according to claim 1, comprising a power supply circuit, a current chip circuit, a gravity sensing circuit and an LED lamp bead circuit which are connected in turn, characterized in that the current chip circuit is in signal connected to the gravity sensing circuit through a switch; the power supply circuit comprises a power supply chip; the current chip circuit comprises a current chip; the gravity sensing circuit comprises a gravity sensing chip; and, the LED lamp bead circuit comprises an LED lamp, a field effect transistor and a first resistor.
